(19) United States
(12) Patent Application Publication
(10) Pub. No.: US 2021/0331622 A1
(43) Pub. Date: Oct. 28, 2021

(54) VEHICULAR AROUND VIEW MONITORING SYSTEM THROUGH ADJUSTMENT OF VIEWING ANGLE OF CAMERA, AND METHOD THEREOF

(71) Applicant: MEEKYUNGTEC CO., LTD, Gyeonggi-do (KR)

(72) Inventors: Se Been OH, Gyeonggi-do (KR); Jung Su KIM, Gyeonggi-do (KR)

(21) Appl. No.: 17/312,845

(22) PCT Filed: Dec. 10, 2019
(86) PCT No.: PCT/KR2019/017331

§ 371 Date: Jun. 10, 2021

(30) Foreign Application Priority Data
Dec. 11, 2018 (KR) 10-2018-0158890

(51) Int. Cl. B60R 1/00; B60R 11/04; H04N 5/232; H04N 5/262; G06F 3/01; G06K 9/00

(52) U.S. Cl. CPC B60R 1/00; B60R 11/04; H04N 5/23299; H04N 5/2628; G06F 3/012; B60R 2011/0085; G06K 9/00845; G06K 9/00268; H04N 5/23219; B60R 2300/605; B60R 2300/20; G06K 9/00228

(57) ABSTRACT

A vehicular AVM (Around View Monitoring) system may include: a rear camera module 10 mounted on an area of a vehicle and configured to acquire an image around the vehicle; an interface unit 20 configured to receive information on a turning angle α at which a driver's face 21 is turned to the left or right and/or a side-to-side displacement l by which the face 21 is moved to the left or right from the central axis of the driver's body; a camera steering processor 30 configured to adjust the angle θ of a camera 11 of the rear camera module 10 according to the information received by the interface unit 20; and an image processor 50 configured to control a display unit 40 to display an image of an area 41 matched with the information received by the interface unit 20, among the surrounding images of the vehicle.

### TECHNICAL FIELD

The present disclosure relates to an AVM (Around View Monitoring) system that provides operational convenience by showing an image, obtained by capturing the surroundings of a vehicle, to a driver in a vehicle, and more particularly, to a vehicular AVM system capable of adjusting the viewing angle of a camera according to the driving state of a vehicle and the state of a driver, and a method thereof.

Furthermore, the present disclosure relates to a vehicular AVM system capable of improving the intuition of an image provided by a display unit thereof, and a method thereof.

### BACKGROUND ART

AVM refers to a system that displays an image around a vehicle, taken by a camera attached to the vehicle, on a monitor within the vehicle, and enables a driver to driven the vehicle while recognizing the situation around the vehicle through the image of the monitor.

In general, when operating a vehicle, a driver may easily recognize and determine a situation ahead in a heading direction, but have difficulties in easily recognizing the left and right sides and the rear side of the vehicle, which correspond to dead zones for a driver's view. Thus, vehicles in operation at present each have units for making up for such problems. For example, a room mirror, a side mirror and a rear view mirror are basically mounted at the inside and side surfaces of the vehicle.

Such view securing units having a typical configuration (e.g., room mirror, side mirror and rear view mirror) are configured as mirrors which enable a driver to recognize an object through light reflection, and distributed and installed at the inside and side surfaces of the vehicle.

Therefore, such conventional view securing units have a mirror structure that enables a driver to recognize an object through a simple light reflection action, and thus form a narrow viewing angle such that a driver's view is blocked by a person, baggage or trailer in a rear seat, and the visibility and reflection range of a subject are inevitably extremely limited.

Recently, an electronic full display mirror has been suggested in order to solve some of the problems of the conventional view securing units. The electronic full display mirror transmits image information acquired through a rear camera to a display unit having a room mirror function, such that the display unit displays the image information to secure a wide view.

In such an electronic full display mirror, however, a phase change does not occur even though the angle between an observer's eyes and a mirror axis is changed, unlike a room mirror. In this case, a driver may have a sense of difference.

### DISCLOSURE

### Technical Problem

Various embodiments are directed to a vehicular AVM system in which an image processor displays a driver an image of an area matched with information on the axis or position of a driver's face, the steering angle of a steering wheel, or the tilt angle of a vehicle body, while a camera steering processor adjusts the angle of a camera of a rear camera module according to such information, and a method thereof. However, such a problem is an example, and the present disclosure is not limited thereto.

### Technical Solution

In an embodiment, a vehicular AVM system may include: a rear camera module mounted on an area of a vehicle and configured to acquire an image around the vehicle; an interface unit configured to receive information on a turning angle at which a driver's face is turned to the left or right and/or a side-to-side displacement by which the face is moved to the left or right from the central axis of the driver's body; a camera steering processor configured to adjust the angle of a camera of the rear camera module according to the information received by the interface unit; and an image processor configured to control a display unit to display an image of an area matched with the information received by the interface unit, among the surrounding images of the vehicle.

In the vehicular AVM system of the embodiment, the interface unit may further receive information on a steering angle of a steering wheel and/or a tilt angle of a vehicle body.

In the vehicular AVM system of the embodiment, the image processor may move the image of the area, displayed through the display unit, or change the display magnification of the image according to the information on the turning angle of the axis of the driver's face, the side-to-side displacement, the steering angle of the steering wheel and/or the tilt angle of the vehicle body.

In the vehicular AVM system of the embodiment, when the position of the driver's face is moved forward or backward, the image processor may increase or decrease the display magnification of the image of the area displayed through the display unit.

In the vehicular AVM system of the embodiment, when the driver's face is turned to the right or left, the camera steering processor may turn the axis of the camera of the rear camera module in the clockwise direction or the counterclockwise direction.

In the vehicular AVM system of the embodiment, when the driver's face is moved to the right or left from the center axis of the driver's body, the camera steering processor may turn the axis of the camera of the rear camera module in the clockwise direction or the counterclockwise direction.

In the vehicular AVM system of the embodiment, when the steering angle of the steering wheel or the tilt angle of the vehicle body is distorted to the left or right while the vehicle moves forward, the camera steering processor may turn the axis of the camera of the rear camera module in the clockwise direction or the counterclockwise direction.

In the vehicular AVM system of the embodiment, when the steering angle of the steering wheel or the tilt angle of the vehicle body is distorted to the left or right while the vehicle moves backward, the camera steering processor may turn the axis of the camera of the rear camera module in the clockwise direction or the counterclockwise direction.

In the vehicular AVM system of the embodiment, when the position of the driver's face is moved, the camera steering processor and/or the image processor may move the image of the area, displayed through the display unit, or turn the axis of the camera further than when the driver's face is turned.

In another embodiment, a vehicular AVM method may include: receiving, by an interface unit, information on a turning angle at which a driver's face is turned to the left or right and/or a side-to-side displacement by which the face is moved to the left or right from the center axis of the driver's body; receiving, by a camera steering processor, the information from the interface unit, and controlling the angle of a camera of a rear camera module according to the information; and controlling, by an image processor, a display unit to display an image of an area matched with information on the turning angle of the axis of the driver's face, the side-to-side displacement, a steering angle of a steering wheel, or tilt angle of the vehicle body, among the surrounding images of the vehicle acquired by the rear camera module.

In the vehicular AVM method of the embodiment, the receiving of the information may include further receiving the information on the steering angle of the steering wheel and/or the tilt angle of the vehicle body, and the controlling of the angle of the camera may include adjusting the angle of the camera by overlapping the information on the turning angle □ of the axis of the face or the side-to-side displacement, received from the interface unit, with the information on the steering angle of the steering wheel or the tilt angle of the vehicle body.

In the vehicular AVM method of the embodiment, the receiving of the information may further include: collecting an image of the driver; and detecting the driver's face.

The vehicular AVM method may further include, when the driver's face is detected: extracting the texture of the driver's face; detecting the eyes, nose and mouth of the driver; and determining the axis or position of the driver's face using detected values of the eyes, nose and mouth of the driver.

The vehicular AVM method may further include turning, by the interface unit, a detection unit to receive the driver information and recognize the driver's face, when the driver's face is not detected.

In the vehicular AVM method of the embodiment, the controlling of the angle of the camera may include turning the axis of the camera of the rear camera module in the clockwise direction or the counterclockwise direction by the angle at which the steering angle of the steering wheel and/or the tilt angle of the vehicle body is distorted to the left or right, when the steering angle of the steering wheel and/or the tilt angle of the vehicle body is distorted to the left or right while the vehicle moves forward, and turning the axis of the camera of the rear camera module in the counterclockwise direction or the clockwise direction by the angle at which the steering angle of the steering wheel and/or the tilt angle r of the vehicle body is distorted to the left or right, when the steering angle of the steering wheel and/or the tilt angle of the vehicle body is distorted to the left or right while the vehicle moves backward.

### Advantageous Effects

In accordance with the embodiments of the present disclosure, the vehicular AVM system and method can improve the intuition of an image provided by a display unit thereof by adjusting the angle of view of the camera according to the running state of the vehicle and the state of the driver, thereby removing a sense of difference which may occur in an electronic full display monitor.

### BRIEF DESCRIPTION OF DRAWINGS

FIG. 1 is a configuration diagram illustrating a vehicular AVM (Around View Monitoring) system in accordance with an embodiment of the present disclosure.

FIG. 2 is a diagram illustrating that the vehicular AVM system in accordance with the embodiment of the present disclosure is applied to the outside of a vehicle.

FIG. 3 is a diagram illustrating that the vehicular AVM system in accordance with the embodiment of the present disclosure is applied to the inside of a vehicle.

FIG. 4 is a diagram illustrating an area in which an image matched with information received through an interface unit, among surrounding images of the vehicle, is displayed through a display unit in accordance with the embodiment of the present disclosure.

FIG. 5A is a diagram illustrating the direction in which a camera axis is turned according to a motion of a driver's face, in an existing full display mirror, and FIG. 5B is a diagram illustrating the direction in which a camera axis is turned according to a motion of a driver's face, in the vehicular AVM system in accordance with the embodiment of the present disclosure.

FIG. 6A is a diagram illustrating the case in which the position of a driver's face is moved, in accordance with the embodiment of the present disclosure, and FIG. 6B is a diagram illustrating the case in which a camera axis is moved when a driver's face is turned, in accordance with the embodiment of the present disclosure.

FIG. 7 is a diagram illustrating the direction in which the camera axis is turned when a driver's face is turned to the right or left in the vehicular AVM system in accordance with the embodiment of the present disclosure.

FIG. 8 is a diagram illustrating the direction in which the camera axis is turned when a driver's face is moved to the right or left from the central axis of a driver's body in the vehicular AVM system in accordance with the embodiment of the present disclosure.

FIG. 9 is a diagram illustrating the direction in which the camera axis is turned when the steering angle of a steering wheel or the tilt angle of a vehicle body is distorted to the left or right while the vehicle moves forward, in accordance with the embodiment of the present disclosure.

FIG. 10 is a diagram illustrating the direction in which the camera axis is turned when the steering angle of the steering wheel or the tilt angle of the vehicle body is distorted to the left or right while the vehicle moves backward in accordance with the embodiment of the present disclosure.

FIG. 11 is a flowchart illustrating a vehicular AVM method in accordance with an embodiment of the present disclosure.

FIG. 12 is a flowchart illustrating a process of calculating a face recognition steering angle in a step in which the interface unit in accordance with the embodiment of the present disclosure receives information.

FIG. 13 is a flowchart illustrating a process of calculating the steering angle of the steering wheel and the tilt angle of the vehicle body in a step of adjusting the angle of a camera in accordance with the embodiment of the present disclosure.

### MODE FOR INVENTION

The above-described objectives, features and advantages will be more clarified through the following embodiments related to the accompanying drawings.

The descriptions of specific structures or functions are only exemplified to describe embodiments according to the concept of the present disclosure, and the embodiments according to the concept of the present disclosure may be carried out in various manners, and should not be construed as being limited to the embodiments described in the specification of the present application.

Since the embodiments according to the concept of the present disclosure can be modified in various manners and have various forms, specific embodiments will be illustrated in the drawings and described in detail in the specification of the present application. However, the embodiments according to the concept of the present disclosure are not limited to the specific embodiments, but should be understood to include all modifications, equivalents and substitutions without departing the spirit and technical range of the present disclosure.

The terms used in the specification of the present application are used only to describe a specific embodiment, and do not intend to limit the present disclosure. The expression in a singular form may include the expression in plural forms unless referred to the contrary. In the present specification, it should be understood that the meaning of “include” or “have” specifies the existence of a property, a number, a step, an operation, an element, a component, or combinations thereof, but does not exclude in advance the existence or addition of one or more other properties, numbers, steps, operations, elements, components, or combinations thereof.

Hereafter, the prevent disclosure will be described in detail by describing preferred embodiments of the present disclosure with reference to the accompanying drawings. Like reference numerals in the drawings represent the same members.

The concept of a vehicle described in the present specification includes an arbitrary transportation mode such as a car or motorcycle, an internal combustion engine vehicle having an engine as a power source, a hybrid vehicle having an engine and electric motor as a power source, and an electric vehicle having an electric motor as a power source. Hereafter, a car among vehicles will be taken as an example for convenience of description.

In the present specification, the situation in which a vehicle runs indicates all situations except the situation in which the vehicle intends to reverse or reverses, and driving and reversing the vehicle are collectively referred to as operation. Therefore, the situation in which the vehicle is reversing includes the state in which the engine gear of the vehicle is put in reverse (R). The situation in which the vehicle runs indicates the state in which a driver is seated in the vehicle or the vehicle is started up. However, the situation is not limited thereto, but may also include the case in which the vehicle is parked.

In the following descriptions, the left side of the vehicle indicates the left side in the moving direction of the vehicle, and the right side of the vehicle indicates the right side in the moving direction of the vehicle.

Furthermore, when the axis of a camera is turned in the clockwise direction or the counterclockwise direction, it indicates that the camera is turned in the clockwise direction or the counterclockwise direction around the axis of the direction in which the camera takes an image of an object.

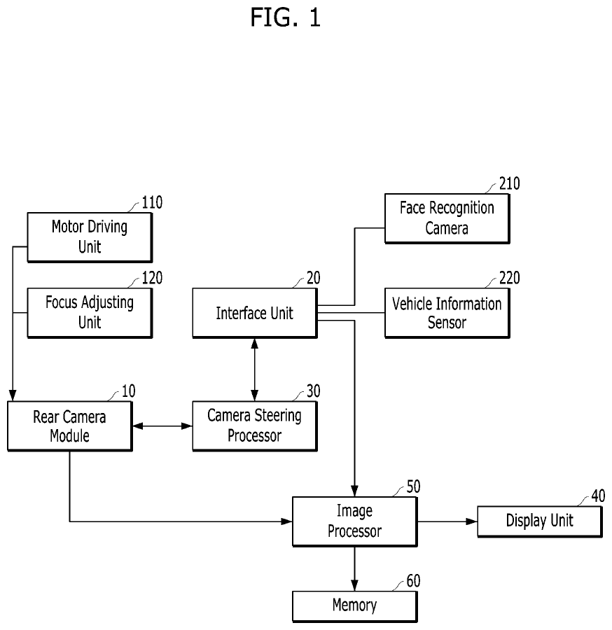

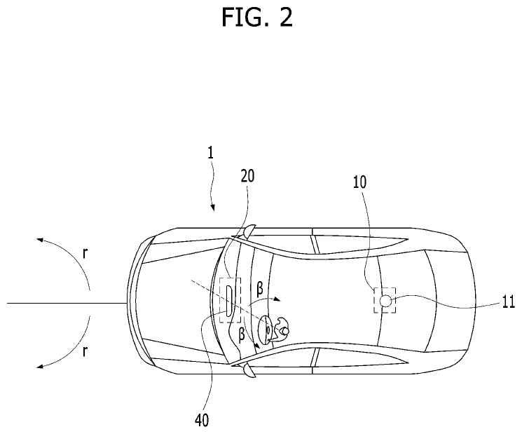

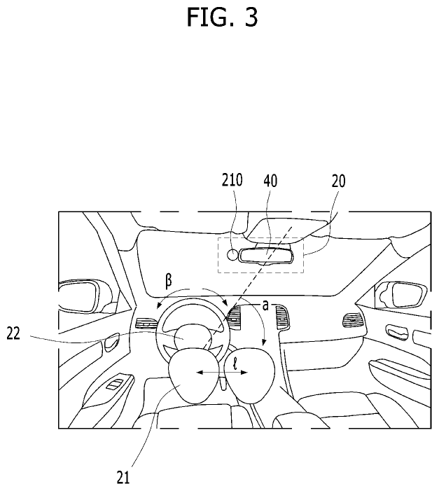

FIG. 1 is a configuration diagram illustrating a vehicular AVM (Around View Monitoring) system in accordance with an embodiment of the present disclosure. FIG. 2 is a diagram illustrating the exterior of a vehicle to which the vehicular AVM system is applied. FIG. 3 is a diagram illustrating the interior of a vehicle in which a driver is seated and to which the AVM system of FIG. 1 is applied.

Referring to FIGS. 1 to 3, the vehicular AVM system in accordance with the embodiment of the present disclosure may include a rear camera module 10, an interface unit 20, a camera steering processor 30 and an image processor 50.

The rear camera module 10 is a device that is mounted at an area of the vehicle so as to acquire an image around the vehicle. The rear camera module 10 may be installed in the center of a rear header or rear deck of a vehicle 1, for example. When the rear camera module 10 is installed in the center of the rear header of the vehicle 1, it is possible to acquire a view in which a field of vision is higher and closer to the driver, and when the rear camera module 10 is installed in the center of the rear deck of the vehicle 1, the rear camera module 10 may be easily interconnected to another rear camera which is generally mounted in the vehicle.

The electrical configuration of a rear camera control device of the rear camera module 10 may roughly include a motor driving unit 110 and a focus adjusting unit 120. The motor driving unit 110 may have a camera 11 installed in the rear camera module 10 and a pan/tilt driving motor capable of adjusting the shooting angle of the camera 11 in top-to-bottom and side-to-side directions, and the focus adjusting unit 120 may adjust the focus of a camera lens.

At this time, the pan/tilt driving motor of the motor driving unit 110 may be implemented as a typical DC motor, and a speed reduction gear (not illustrated) capable of reducing the rotation speed of the motor driving unit 110 may be mounted on the shaft of the pan/tilt driving motor. The motor driving unit 110 may be implemented as a typical transistor circuit or the like, and configured to supply power to the pan/tilt driving motor or cut off the power supply under control of a control unit connected thereto.

Furthermore, the rear camera module 10 may not be limited to the motor driving unit 110, and may be made of a magnetic material or shape memory alloy to adjust the angle of the shaft.

In the above example, it has been described that the rear camera module 10 is mounted at the rear of the vehicle. However, the present disclosure is not limited thereto, but the rear camera module 10 may be installed at a random position of the vehicle as long as the rear camera module 10 can take a rear image of the vehicle.

Furthermore, in the above example, it has been described that the rear camera module 10 includes one camera 11. However, the present disclosure is not limited thereto, but the rear camera module 10 may include a plurality of cameras, and synthesize and process information, acquired by the plurality of cameras, through processors which will be described below. In this case, the axes of the plurality of cameras may be set to have a proper angle of view, such that images acquired by adjacent cameras partially overlap each other. By synthesizing the image information acquired through the plurality of cameras, it is possible to acquire a wide-view image and a clearer image.

The interface unit 20 may be configured to receive a turning angle α at which a driver's face 21 is turned to the left or right and/or a side-to-side displacement l by which the face 21 is moved to the left or right from the central axis of a driver's body.

Specifically, the turning angle α indicates how much the driver turns the face 21 to the left or right from the central axis of the driver's face 21, and the side-to-side displacement l indicates how much the central axis of the driver's face 21 deviates from the central axis of the driver's body.

In the above example, the turning angle α and the side-to-side displacement l have been defined as described above. However, the movement of a predetermined portion of the driver's face or body may be traced to define the turning angle α and the side-to-side displacement l.

At this time, the turning angle α and the side-to-side displacement l may be based on the driver's gaze toward a face recognition camera 210. However, the present disclosure is not limited thereto, but the turning angle α and the side-to-side displacement l may be based on the driver's gaze toward the front of the vehicle during driving.

In order to receive such information, the interface unit 20 is connected to the face recognition camera 210 and a vehicle information sensor 220. The face recognition camera 210 is installed in front of a driver and configured to capture the face of the driver, and the vehicle information sensor 220 is configured to acquire information of the vehicle.

The face recognition camera 210 serves to collect an image of the driver, and detects the face of the driver. For example, the face recognition camera 210 may acquire an image of the driver using an infrared LED regardless of day and night, and detect the eye, nose, mouth and the like of the driver from the image.

A processor (e.g. GPU) within the interface unit 20 may calculate the face angle of the driver and the left, right, top and bottom positions of the face thereof from the detected information, based on the heights and left/right positions of the eye, nose, mouth and the like of the driver. At this time, an image matching algorithm through eye tracking may be used.

The face recognition camera 210 may be located in front of the driver, or located on the left side of a display unit 40 configured as a room mirror. When the face recognition camera 210 is located in front of the driver, the face recognition camera 210 may easily recognize the face of the driver. When the face recognition camera 210 is located on the left side of the display unit 40, the face recognition camera 210 may be integrated with the display unit 40 without a separate mounting unit.

The vehicle information sensor 220 senses a signal related to the running of the vehicle 1. For this operation, a sensing unit may include a collision sensor, a wheel sensor, a speed sensor, a tilt sensor, a position module, a vehicle forward/backward sensor, and a steering sensor by the turn of the steering wheel.

Thus, the vehicle information sensor 220 may acquire a sensing signal for vehicle collision information, vehicle direction information, vehicle position information, vehicle angle information, vehicle speed information, vehicle acceleration information, vehicle tilt information, vehicle forward/backward information, steering wheel turning angle or the like.

In particular, the vehicle information sensor 220 may acquire information on the steering angle β of a steering wheel 22 and/or the tilt angle r of a vehicle body 23.

The information of the face recognition camera 210 and the vehicle information sensor 220 may be all used to adjust the angle θ of the rear camera 11 as will be described below.

However, the descriptions of the embodiment of the present disclosure will be focused on a system that adjusts the angle θ of the rear camera 11 according to information on the turning angle α at which the driver's face 21 captured by the face recognition camera 210 is turned to the left or right and/or the side-to-side displacement l by which the face 21 is moved to the left or right from the center axis of a driver's body, and information on the steering angle β of the steering wheel 22 and/or the tilt angle r of the vehicle body 23, which are acquired by the vehicle information sensor 220.

The camera steering processor 30 may control the angle θ of the camera 11 of the rear camera module 10 according to information received by the interface unit 20.

Specifically, the above-described pieces of information of the driver and the vehicle are received by the interface unit 20 through the face recognition camera 210 and the vehicle information sensor 220, and the camera steering processor 30 calculates how much to adjust the angle θ of the camera 11 of the rear camera module 10 by processing the information received from the interface unit 20, and adjusts the angle θ according to the calculated value.

The detailed relationship between the angles θ of the camera 11 of the rear camera module 10 based on the information processed by the camera steering processor 30 will be described below.

At this time, among the pieces of information received by the camera steering processor from the interface unit 20, the turning angle α at which the driver's face 21 is turned to the left or right and/or the side-to-side displacement l by which the face 21 is moved to the left or right from the central axis of the driver's body, and the information on the steering angle β of the steering wheel 22 and/or the tilt angle r of the vehicle body 23 occupy a considerable portion in adjusting the angle θ of the camera.

In particular, when only the gaze of the driver's face 21 is recognized as in the conventional driver recognition module, the conventional driver recognition module only determines at which portion of the face recognition camera the driver is gazing. Thus, in reality, it is difficult to determine the entire motion of the driver when the driver looks into a rear view mirror (room mirror).

Therefore, in the embodiment of the present disclosure, the interface unit 20 may extract the texture of the driver's face, determine portions of the face, such as the eyes, nose and mouth, and simultaneously calculate the turning angle α at which the driver's face 21 is turned to the left or right and the side-to-side displacement l by which the face 21 is moved to the left or right from the central axis of the driver's body.

When a considerable portion of the driver's face is turned as in case of rotational driving, sharp turning or rear end parking, or when the turning angle α or the side-to-side displacement l of the face is large, it may indicate that the driver has a strong intention to recognize a dead zone around the vehicle. Therefore, the vehicular AVM system in accordance with the embodiment of the present disclosure can actively reflect the driver's intention and rapidly show the driver the image of the dead zone without a separate device manipulation, when the driver needs to see the dead zone.

In the embodiment of the present disclosure, the reason why the camera steering processor 30 collectively calculates the turning angle α at which the driver's face 21 is turned to the left or right and the side-to-side displacement l by which the face 21 is moved to the left or right from the central axis of the driver's body is as follows. For example, when the driver needs to make a sharp turn, the driver needs to rapidly cope with the situation in which a surrounding vehicle is in a dead zone. At this time, since the side-to-side displacement l by which the driver instinctively moves the face 21 to the left or right from the central axis of the driver's body is considerably increased, the side-to-side displacement l needs to be included as a factor to adjust the angle θ of the camera.

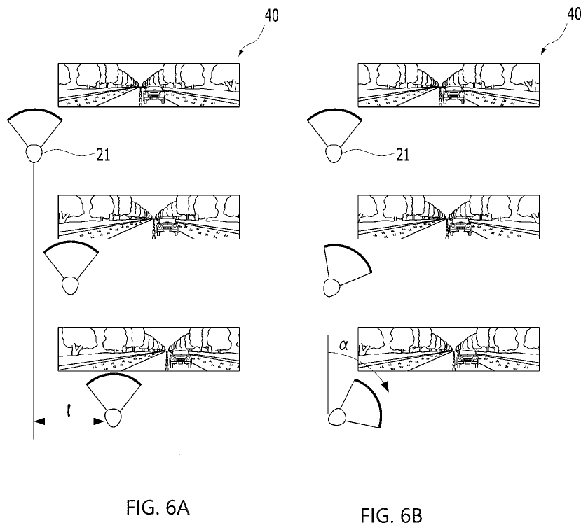

To this end, in the present embodiment, when the position of the driver's face is moved as illustrated in FIG. 6A, the camera steering processor 30 and/or the image processor 50 may move the image of an area 41 displayed through the display unit or turn the axis of the camera 11 further than when the driver's face 21 is turned as illustrated in FIG. 6B.

At this time, the movement speed of the image or the turning speed of the camera axis as well as the displacement of the image or the turning amount of the camera axis may be increased to allow the driver to rapidly see the dead zone in case of a sharp turn or the like.

Furthermore, since the above-described configuration can be applied to the camera steering processor 30 and the image processor 50, the turn of the camera axis and the movement of the image displayed through the display unit may be naturally interconnected.

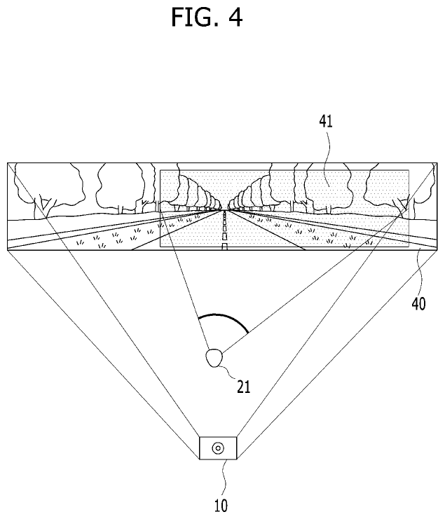

Referring to FIG. 4, the image processor 50 may control an image of the area 41, matched with the information received by the interface unit 20 among the surrounding images of the vehicle 1, to be displayed through the display unit 40.

At this time, the display unit 40 in the vehicle may be implemented as a device such as a room mirror, for example, and formed in a flat type, and have a size that is properly adjusted to selectively expand and output only a necessary portion of the image around the vehicle.

The display unit 40 may display information processed by the image processor 50. Specifically, as described above, the camera steering processor 30 processes the respective pieces of information of the driver and the vehicle, received through the interface unit 20, and adjusts the angle θ of the camera 11 of the rear camera module 10, and the image around the vehicle, captured through the camera 11 of the rear camera module 10 whose angle is adjusted as described above, is received again by the interface unit 20, and processed by the image processor 50. Then, the image of the area 41 matched with the information received by the interface unit 20 is outputted through the display unit 40.

That is, the image processor 50 may move the image of the area 41, displayed through the display unit 40, or change the display magnification of the image, according to the turning angle α of the axis of the driver's face 21, the side-to-side displacement l, the steering angle β of the steering wheel 22 and/or the tilt angle r of the vehicle body 23.

Furthermore, the information processed by the image processor 50 may be stored in a memory 60. For example, the faces of drivers have different shapes and heights, and the turning angles α at which the drivers' faces 21 are turned to the left or right and/or the side-to-side displacements l by which the faces 21 are moved to the left or right from the center axes of the drivers' bodies are different from one another depending on the driving habits of the drivers. Therefore, plural pieces of information based on the individual characteristics of the drivers may be accumulated in the memory 60, in order to correct, in real time, standards which are required for measuring the shapes and heights of the drivers' faces, and the turning angles α at which the drivers' faces 21 are turned to the left or right and/or the side-to-side displacements l by which the faces 21 are moved to the left or right from the center axes of the drivers' bodies. Therefore, the most suitable standards can be set for each of the drivers.

The image of the area 41, matched with the information received by the interface unit 20 through the display unit 40, may be outputted through an existing method of acquiring the entire image through a rear camera, and then separately displaying a partial image in the entire image while displaying the entire image, such that the partial area is moved by a driver's manipulation.

However, the above-described method has a limitation in securing a rear view of the vehicle through one camera. Furthermore, a method of synthesizing images acquired through a plurality of cameras and then allowing a driver to move an internal area of the synthesized image has low image display precision. In addition, since the method needs to go through such a process, a considerable delay occurs during the image processing operation.

In the present disclosure, the above-described method may be employed because the camera 11 of the rear camera module 10 is directly moved. Desirably, however, the entire image is not outputted, but only the image of the area 41 matched with the information, which is received by the interface unit 20 through the display unit 40 based on an image acquired by the camera 11 which is moved by reflecting the states of the driver and vehicle, may be outputted.

At this time, the image around the vehicle may be acquired through a plurality of cameras as well as one camera 11 as described above. Even in this case, the operation method of the camera 11 in accordance with the embodiment of the present disclosure is applied in the same manner to each of the cameras. In this case, since the images acquired through the plurality of cameras which are moved by reflecting the states of the driver and the vehicle are synthesized, the method may have much higher precision than a method of synthesizing images acquired through a plurality of fixed cameras in the related art. Furthermore, since images acquired through adjacent cameras are synthesized, it is possible to considerably reduce the delay in the image processing operation.

Through this operation, only a portion required for the driver's driving in the image around the vehicle, acquired through the camera 11 of the rear camera module 10, is processed by the image processor 50 and outputted to the display unit 40.

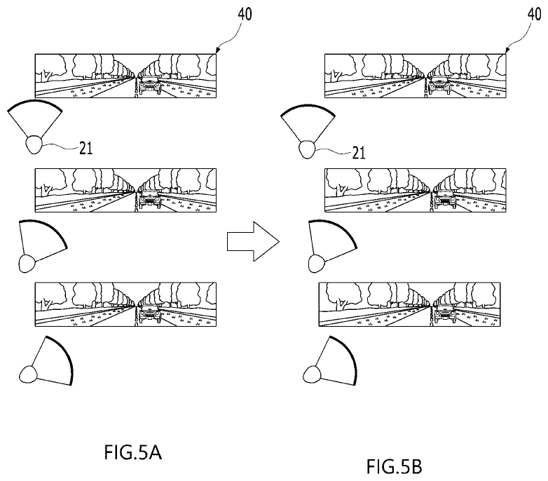

In particular, as illustrated in FIG. 5A, an existing room mirror outputs a screen captured from the rear as it is in many cases. As illustrated in FIG. 5B, however, the output method in accordance with the embodiment of the present disclosure may move the axis of the camera 11 of the rear camera module 10 according to the movement of the driver's face 21, and thus acquire a more natural view and perspective in connection with the state of the driver.

In addition to the above-described configuration, when the position of the driver's face 21 is moved forward or backward, the image processor 50 may increase or decrease the display magnification of the image of the area 41 displayed through the display unit 40.

Typically, the driver keeps the face 21 close to the room mirror when intending to expand and see a vehicle in a dead zone during rear end parking, for example. In the embodiment of the present disclosure, when the driver keeps the face 21 close to the room mirror, the image processor 50 may increase the display magnification of the image of the area 41 displayed through the display unit 40, and properly provide the driver with an expanded image around the vehicle as information required for the driver.

On the other hand, when the driver is at an intersection or the like, the driver may intend to see the entire situation around the vehicle as well as the dead zone. In this case, the driver typically keeps the face 21 away from the room mirror. In the embodiment of the present disclosure, when the driver keeps the face 21 away from the room mirror, the image processor 50 may decrease the display magnification of the image of the area 41 displayed through the display unit 40, and properly provide the driver with the entire image around the vehicle as information required for the driver.

According to such a configuration, the turning angle α of the axis of the driver's face 21 or the information of the side-to-side displacement l may be both reflected into the image processor 50. Thus, a field of vision desired by the driver during driving may be reflected to the maximum in order to provide convenience to the driver, and information suitable for the situation may be provided to significantly reduce an accident risk of the driver.

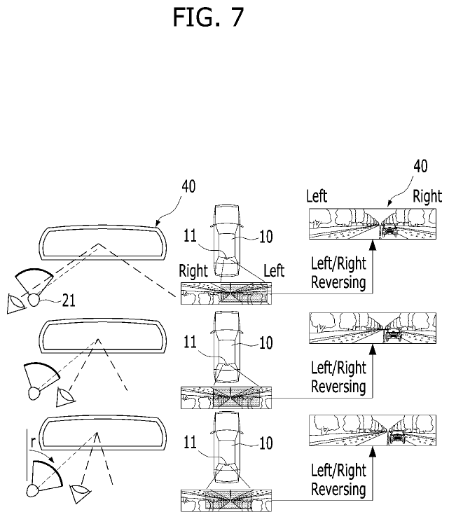

So far, the components of the vehicular AVM system in accordance with the embodiments of the present disclosure have been described. Hereafter, how the vehicular AVM system in accordance with the present disclosure reflects the state of a driver or vehicle according to the direction in which the vehicle makes a turn will be described for respective types with reference to FIGS. 7 to 10.

[When Driver's Face is Turned to Right or Left]

When the axis of the driver's face 21 is turned to the right or left, the camera steering processor 30 may turn the axis of the camera 11 of the rear camera module 10 in the clockwise direction or the counterclockwise direction.

For example, when the driver turns the face 21 to the right to see the room mirror as illustrated in FIG. 7, the face recognition camera 210 recognizes the turning angle α at which the face 21 of the driver is turned to the right, and the interface unit 20 transfers information on the turning angle α to the camera steering processor 30.

The camera steering processor 30 turns the axis of the camera 11 of the rear camera module 10 in the clockwise direction according to the information, such that the camera 11 is turned toward the dead zone on the left side of the vehicle. Therefore, the driver can easily secure a field of vision for the dead zone on the left side of the vehicle.

[When Driver's Face is Moved to Left or Right from Central Axis of Driver's Body]

When the driver's face 21 is moved to the right or left from the central axis of the driver's body, the camera steering processor 30 may turn the axis of the camera 11 of the rear camera module 10 in the clockwise direction or the counterclockwise direction.

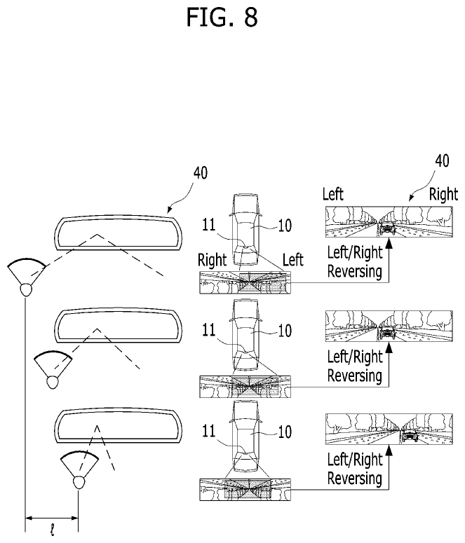

For example, when the driver moves the face 21 to the right from the central axis of the driver's body in order to see the room mirror as illustrated in FIG. 8, the face recognition camera 210 recognizes the displacement l by which the face 21 is moved to the right from the center axis of the driver's body, and the interface unit 20 transfers information on the displacement l to the camera steering processor 30.

The camera steering processor 30 turns the axis of the camera 11 of the rear camera module 10 in the clockwise direction according to the information, such that the camera 11 is turned toward the dead zone on the left side of the vehicle. Therefore, the driver can easily secure a field of vision for the dead zone on the left side of the vehicle.

[When Steering Angle of Steering Wheel or Tilt Angle of Vehicle Body is Distorted to Left or Right while Vehicle Moves Forward]

When the steering angle of the steering wheel 22 or the tilt angle of the vehicle body is distorted to the left or right while the vehicle moves forward, the camera steering processor 30 may turn the axis of the camera 11 of the rear camera module 10 in the clockwise direction or the counterclockwise direction.

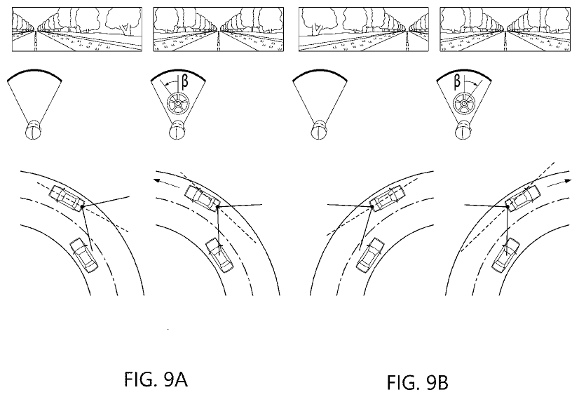

For example, when the driver turns the steering wheel to the ‘left’ as illustrated in FIG. 9A while driving the vehicle forward, the vehicle information sensor 220 recognizes the steering angle β of the steering wheel 22 and/or the tilt angle r of the vehicle body 23, which have/has been distorted to the left, and the interface unit 20 transfers information on the steering angle and the tilt angle to the camera steering processor 30.

The camera steering processor 30 turns the axis of the camera 11 of the rear camera module 10 in the clockwise direction according to the information, such that the camera 11 is turned toward the dead zone on the left side of the vehicle. Therefore, the driver can easily secure a field of vision for the dead zone on the left side of the vehicle.

Furthermore, when the driver turns the steering wheel to the ‘right’ as illustrated in FIG. 9B while driving the vehicle forward, the vehicle information sensor 220 recognizes the steering angle β of the steering wheel 22 and/or the tilt angle r of the vehicle body 23, which have/has been distorted to the right, and the interface unit 20 transfers information on the steering angle and the tilt angle to the camera steering processor 30.

The camera steering processor 30 turns the axis of the camera 11 of the rear camera module 10 in the counterclockwise direction according to the information, such that the camera 11 is turned toward the dead zone on the right side of the vehicle. Therefore, the driver can easily secure a field of vision for the dead zone on the right side of the vehicle.

Thus, when making a sharp turn to the left or right while driving the vehicle forward, the driver can rapidly secure a field of vision for a vehicle which approaches from the left or right rear side of a lane, thereby reducing an accident risk which frequently occurs in the case that the driver makes a sharp turn by turning the steering wheel on a curved road.

[When Steering Angle of Steering Wheel or Tilt Angle of Vehicle Body is Distorted to Left or Right while Vehicle Moves Backward]

When the steering angle of the steering wheel 22 or the tilt angle of the vehicle body is distorted to the left or right while the vehicle moves backward, the camera steering processor 30 may turn the axis of the camera 11 of the rear camera module 10 in the clockwise direction or the counterclockwise direction.

When the steering angle of the steering wheel 22 or the tilt angle of the vehicle body is distorted to the left or right while the vehicle moves backward, the camera steering processor 30 may turn the axis of the camera 11 of the rear camera module 10 in the clockwise direction or the counterclockwise direction.

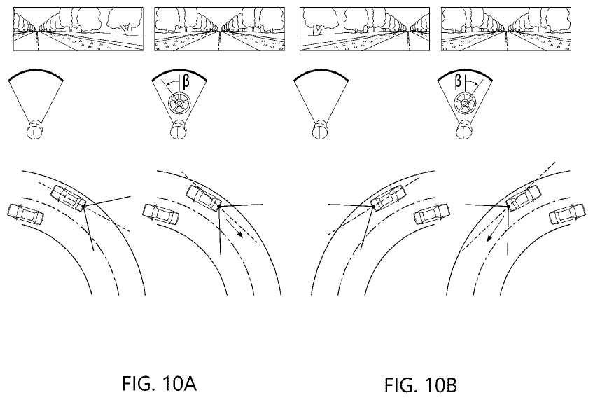

For example, when the driver turns the steering wheel to the ‘left’ as illustrated in FIG. 10A while the vehicle moves backward, the vehicle information sensor 220 recognizes the steering angle β of the steering wheel 22 and/or the tilt angle r of the vehicle body 23, which have/has been distorted to the left, and the interface unit 20 transfers information on the steering angle and the tilt angle to the camera steering processor 30.

The camera steering processor 30 turns the axis of the camera 11 of the rear camera module 10 in the clockwise direction according to the information, such that the camera 11 is turned toward the dead zone on the left side of the vehicle. Therefore, the driver can easily secure a field of vision for the dead zone on the left side of the vehicle.

Furthermore, when the driver turns the steering wheel to the ‘right’ as illustrated in FIG. 10B while the vehicle moves backward (reverses), the vehicle information sensor 220 recognizes the steering angle β of the steering wheel 22 and/or the tilt angle r of the vehicle body 23, which have/has been distorted to the right, and the interface unit 20 transfers information on the steering angle and the tilt angle to the camera steering processor 30.

The camera steering processor 30 turns the axis of the camera 11 of the rear camera module 10 in the counterclockwise direction according to the information, such that the camera 11 is turned toward the dead zone on the right side of the vehicle. Therefore, the driver can easily secure a field of vision for the dead zone on the right side of the vehicle.

Thus, when reversing the vehicle or backing the vehicle into a parking space, the driver can rapidly secure a field of view for a vehicle approaching from the left or right rear side of the driver or a vehicle which has been parked in advance, thereby reducing an accident risk which frequently occurs when the driver does not recognize another vehicle in the dead zone at the rear of the vehicle driven by the driver.

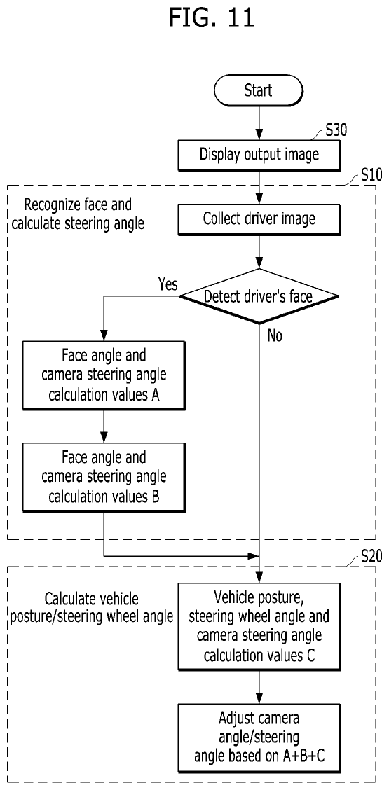

So far, how the vehicular AVM system in accordance with the embodiment of the present disclosure reflects the state of the driver or the vehicle according to the direction in which the vehicle makes a turn has been described for the respective types. Hereafter, a method for operating a vehicular AVM system in accordance with an embodiment of the present disclosure will be described with reference to FIGS. 11 to 13.

Referring to FIGS. 11 to 13, a vehicular AVM method in accordance with an embodiment of the present disclosure may include step S10 of receiving, by the interface unit 20, information, step S20 of adjusting the angle θ of the camera 11, and step S30 of displaying an image through the display unit 40.

In step S10 of receiving the information, the interface unit 20 receives information on the turning angle α at which the driver's face 21 is turned to the left or right and/or the side-to-side displacement l by which the face 21 is moved to the left or right from the center axis of the driver's body.

At this time, the interface unit 20 may further receive information on the steering angle β of the steering wheel 22 and/or the tilt angle r of the vehicle body 23.

In step S20 of adjusting the angle θ of the camera 11, the camera steering processor 30 receives, from the interface unit 20, information on the turning angle α at which the driver's face 21 is turned to the left or right and/or the side-to-side displacement l by which the face 21 is moved to the left or right from the center axis of the driver's body, and controls the angle θ of the camera 11 of the rear camera module 10 according to the information.

At this time, the camera steering processor 30 may adjust the angle θ of the camera 11 by overlapping the information on the turning angle α of the axis of the driver's face 21 or the side-to-side displacement l, which are received from the interface unit 20, with the information on the steering angle β of the steering wheel 22 and/or the tilt angle r of the vehicle body 23.

In step S30 of displaying the image through the display unit 40, the image processor 50 controls the display unit 40 to display the image of the area 41, matched with the information on the turning angle α of the axis of the driver's face 21 or the side-to-side displacement l and the information on the steering angle β of the steering wheel 22 and/or the tilt angle r of the vehicle body 23, among the images around the vehicle, acquired by the rear camera module 10.

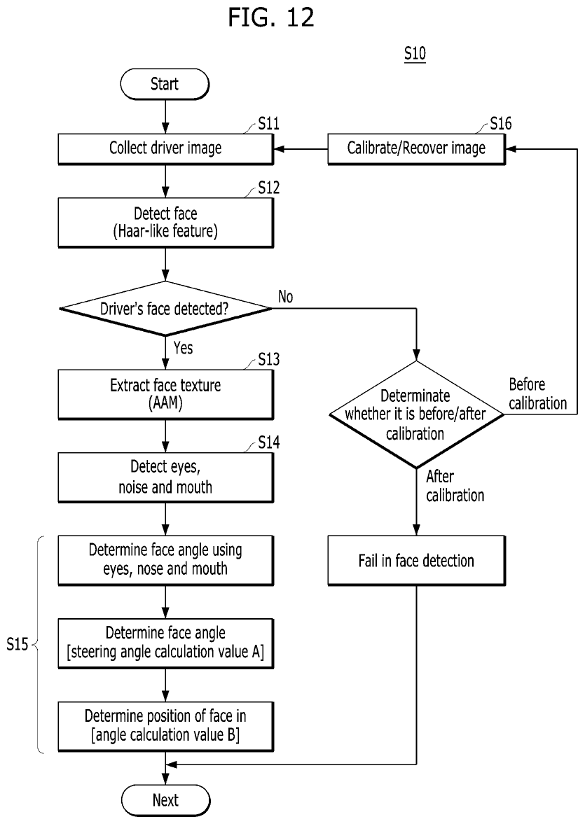

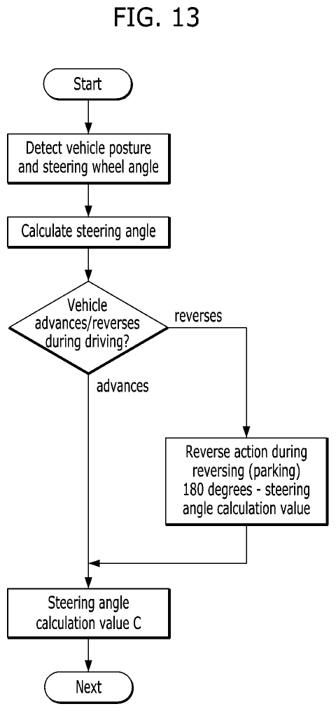

Hereafter, a process of calculating a face recognition steering angle in step S10 of receiving the information and a process of calculating the steering angle of the steering wheel and the tilt angle of the vehicle body in step S20 of controlling the angle of the camera 11 will be described in detail with reference to FIGS. 12 and 13, respectively.

Referring to FIG. 12, step S10 of receiving the information may further include step S11 of collecting an image of the driver and step S12 of detecting the driver's face.

At this time, when the driver's face is detected in step S12 of detecting the driver's face, step S10 may further include step S13 of extracting the texture of the driver's face; step S14 of detecting the eyes, nose and mouth of the driver; and step S15 of determining the axis or position of the driver's face using the detected values of the eyes, nose and mouth of the driver.

On the other hand, when the driver's face is not detected in step S12 of detecting the driver's face, step S10 may further include step S16 of correcting a driver image which is collected to recognize the driver's face.

Referring to FIG. 13, step S20 of adjusting the angle of the camera 11 may include turning the axis of the camera 11 of the rear camera module 10 in the clockwise direction or the counterclockwise direction by the angle at which the steering angle β of the steering wheel 22 and/or the tilt angle r of the vehicle body 23 is distorted to the left or right, when the steering angle β of the steering wheel 22 and/or the tilt angle r of the vehicle body 23 is distorted to the left or right while the vehicle moves forward (advances).

Further, step S20 of adjusting the angle of the camera 11 may include turning the axis of the camera 11 of the rear camera module 10 in the counterclockwise direction or the clockwise direction by the angle at which the steering angle β of the steering wheel 22 and/or the tilt angle r of the vehicle body 23 is distorted to the left or right, when the steering angle β of the steering wheel 22 and/or the tilt angle r of the vehicle body 23 is distorted to the left or right while the vehicle moves backward (reverses).

While various embodiments have been described above, it will be understood to those skilled in the art that the embodiments described are by way of example only. Accordingly, the disclosure described herein should not be limited based on the described embodiments.

1. A vehicular AVM (Around View Monitoring) system comprising:
a rear camera module mounted on an area of a vehicle and configured to acquire an image around the vehicle;
an interface unit configured to receive information on a turning angle α at which a driver's face is turned to the left or right and/or a side-to-side displacement by which the face is moved to the left or right from the central axis of the driver's body;
a camera steering processor configured to adjust the angle θ of a camera of the rear camera module according to the information received by the interface unit; and
an image processor configured to control a display unit to display an image of an area matched with the information received by the interface unit, among the surrounding images of the vehicle.

2. The vehicular AVM system of claim 1, wherein the interface unit further receives information on a steering angle β of a steering wheel 22 and/or a tilt angle r of a vehicle body.

3. The vehicular AVM system of claim 2, wherein the image processor moves the image of the area, displayed through the display unit, or changes the display magnification of the image according to the information on the turning angle α of the axis of the driver's face, the side-to-side displacement, the steering angle β of the steering wheel and/or the tilt angle r of the vehicle body.

4. The vehicular AVM system of claim 1, wherein when the position of the driver's face is moved forward or backward, the image processor increases or decreases the display magnification of the image of the area displayed through the display unit.

5. The vehicular AVM system of claim 1, wherein when the driver's face is turned to the right or left, the camera steering processor turns the axis of the camera of the rear camera module in the clockwise direction or the counterclockwise direction.

6. The vehicular AVM system of claim 1, wherein when the driver's face is moved to the right or left from the center axis of the driver's body, the camera steering processor turns the axis of the camera of the rear camera module in the clockwise direction or the counterclockwise direction.

7. The vehicular AVM system of claim 2, wherein when the steering angle of the steering wheel or the tilt angle of the vehicle body is distorted to the left or right while the vehicle moves forward, the camera steering processor turns the axis of the camera of the rear camera module in the clockwise direction or the counterclockwise direction.

8. The vehicular AVM system of claim 2, wherein when the steering angle of the steering wheel or the tilt angle of the vehicle body is distorted to the left or right while the vehicle moves backward, the camera steering processor turns the axis of the camera of the rear camera module in the clockwise direction or the counterclockwise direction.

9. The vehicular AVM system of claim 3, wherein when the position of the driver's face is moved, the camera steering processor and/or the image processor move/moves the image of the area, displayed through the display unit, or turn/turns the axis of the camera further than when the driver's face is turned.

10. A vehicular AVM method comprising:
a step S10 of receiving, by an interface unit, information on a turning angle α at which a driver's face is turned to the left or right and/or a side-to-side displacement l by which the face is moved to the left or right from the center axis of the driver's body;
a step S20 of receiving, by a camera steering processor, the information from the interface unit, and controlling the angle θ of a camera of a rear camera module according to the information; and
a step S30 of controlling, by an image processor, a display unit to display an image of an area matched with information on the turning angle α of the axis of the driver's face, the side-to-side displacement, a steering angle β of a steering wheel, or tilt angle r of the vehicle body, among the surrounding images of the vehicle acquired by the rear camera module.

11. The vehicular AVM method of claim 10, wherein the step S10 of receiving the information comprises further receiving the information on the steering angle β of the steering wheel and/or the tilt angle r of the vehicle body, and
the step S20 of controlling the angle of the camera comprises adjusting the angle θ of the camera by overlapping the information on the turning angle α□ of the axis of the face or the side-to-side displacement l, received from the interface unit, with the information on the steering angle β of the steering wheel or the tilt angle r of the vehicle body.

12. The vehicular AVM method of claim 10, wherein the step S10 of receiving the information further comprises:
a step S11 of collecting an image of the driver; and
a step S12 of detecting the driver's face.

13. The vehicular AVM method of claim 12, further comprising, when the driver's face is detected:
a step S13 of extracting the texture of the driver's face;
a step S14 of detecting the eyes, nose and mouth of the driver; and
a step S15 of determining the axis or position of the driver's face using detected values of the eyes, nose and mouth of the driver.

14. The vehicular AVM method of claim 12, further comprising step S16 of turning, by the interface unit, a detection unit 21 to receive the driver information and recognize the driver's face, when the driver's face is not detected.

15. The vehicular AVM method of claim 11, wherein the step S20 of controlling the angle of the camera comprises turning the axis of the camera of the rear camera module in the clockwise direction or the counterclockwise direction by the angle at which the steering angle β of the steering wheel and/or the tilt angle r of the vehicle body is distorted to the left or right, when the steering angle β of the steering wheel and/or the tilt angle r of the vehicle body is distorted to the left or right while the vehicle moves forward, and turning the axis of the camera of the rear camera module in the counterclockwise direction or the clockwise direction by the angle at which the steering angle β of the steering wheel and/or the tilt angle r of the vehicle body is distorted to the left or right, when the steering angle β of the steering wheel and/or the tilt angle r of the vehicle body is distorted to the left or right while the vehicle moves backward.
